(19) United States
(12) Patent Application Publication
(10) Pub. No.: US 2026/0270377 A1
(43) Pub. Date: Sep. 10, 2026

(54) METHOD AND APPARATUS FOR CORRECTING BRIGHTNESS OF MULTI-VIEW IMAGES

(71) Applicant: ELECTRONICS AND TELECOMMUNICATIONS RESEARCH INSTITUTE, Daejeon (KR)

(72) Inventor: Man-Hee LEE, Daejeon (KR)

(21) Appl. No.: 19/381,406

(22) Filed: Nov. 6, 2025

(30) Foreign Application Priority Data
Mar. 5, 2025 (KR) 10-2025-0028247

(51) Int. Cl. H04N 13/133; G06T 5/50; G06T 5/92

(52) U.S. Cl. CPC H04N 13/133; G06T 5/50; G06T 5/92; G06T 2207/10024

(57) ABSTRACT

Disclosed herein are a method and an apparatus for correcting brightness of multi-view images. The apparatus includes a storage configured to store a plurality of multi-view images, and a controller configured to calculate tie points in the plurality of multi-view images, store color values of pixels, corresponding to the tie points in multi-view images used to calculate the tie points, in the storage in association with the tie points, convert the color values of the pixels into YCbCr channels, select a reference image from among the multi-view images based on at least one of a luminance (Y) value of converted color values or a preset rule, or a combination thereof, calculate a brightness correction graph between the reference image, selected using the Y value, and an additional multi-view image, and correct brightness of the additional multi-view image using the brightness correction graph.

### CROSS REFERENCE TO RELATED APPLICATION

This application claims the benefit of Korean Patent Application No. 10-2025-0028247, filed Mar. 5, 2025, which is hereby incorporated by reference in its entirety into this application.

### BACKGROUND OF THE INVENTION

### 1. Technical Field

The present disclosure relates generally to a method and an apparatus for correcting brightness of multi-view images, and more particularly to a method and apparatus for correcting brightness of multi-view images, which correct brightness of multi-view images so that the brightness levels of respective multi-view images become similar to one another.

### 2. Description of the Related Art

As methods for correcting brightness of one image, there are various methods that are mathematically modeled, such as histogram equalization or gamma correction. However, there is a disadvantage in that, when the above method is applied to respective multi-view images for three-dimensional (3D) space restoration in which the characteristics of cameras and illumination environments differ, consistent results cannot be obtained.

Meanwhile, even in the field of color transfer in which a color distribution of a reference image, among two or more images, is transferred to a target image, there are various methods including not only conventional computational methods that utilize the mean and variance of the global color distribution of images or utilize local correspondences between images, but also recent methods that utilize deep learning. However, as in the cases described above, it is difficult to guarantee consistent brightness and color correction results for multi-view images, and in particular, correction is performed without accurately considering the correspondence for an object of interest where brightness and illumination consistency are important, thus resulting in a disadvantage in that mismatch in surface continuity occurs in the result of 3D reconstruction.

Korean Patent No. 10-0809349 discloses technology that divides one image into multiple segmented regions, calculates brightness distributions of respective segmented regions, determines a main area in the corresponding image, and corrects the brightness of the main area to target brightness.

Korean Patent No. 10-0925629 discloses a technology in which multiple intervals are set in YCbCr channels in one image, cumulative values of respective intervals are calculated to determine a valid interval for automatic white balance, an average YCbCr value for correction is calculated and converted into RGB channels, and then a white balance gain is reflected.

Korean Patent No. 10-0668073 discloses technology in which images are captured with four or more cameras so that each image fully covers the same plane, each captured image is converted into a YCbCr space to extract a Y channel and in which a reference brightness value is calculated from the Y channel of each camera, a brightness difference map is calculated using the reference brightness value, and the Y channel and the brightness difference map are added together, thus processing compensation for brightness uniformity for each camera.

### SUMMARY OF THE INVENTION

Accordingly, the present disclosure has been made keeping in mind the above problems occurring in the prior art, and an object of the present disclosure is to provide a method and an apparatus for correcting brightness of multi-view images, which can consistently correct brightness in multi-view images.

Another object of the present disclosure is to provide a method and an apparatus for correcting brightness of multi-view images, which can eliminate a mismatch in surface continuity in the result of 3D reconstruction.

A further object of the present disclosure is to provide a method and an apparatus for correcting brightness of multi-view images, which can consistently correct brightness of multi-view images in conformity with the brightness of a captured scene.

In accordance with an aspect of the present disclosure to accomplish the above objects, there is provided a method for correcting brightness of multi-view images, including calculating tie points in a plurality of multi-view images, and storing color values of pixels, corresponding to the tie points in multi-view images used to calculate the tie points, in association with the tie points, converting the stored color values of the pixels into YCbCr channels, selecting a reference image from among the plurality of multi-view images based on at least one of a luminance (Y) value of converted color values or a preset rule, or a combination thereof, calculating a brightness correction graph between the reference image, selected based on the luminance (Y) value, and an additional multi-view image, and correcting brightness of the additional multi-view image using the calculated brightness correction graph. Here, the color values of the pixels corresponding to the tie points may be stored in data structures of the tie points. Here, the preset rule may be defined by a user.

Here, storing the color values of the pixels in association with the tie points may include extracting feature points from the multiple the plurality of multi-view images and calculating correspondences between the extracted feature points by matching the feature points, estimating pieces of camera geometric information of the plurality of multi-view images based on the calculated correspondences, and calculating the tie points based on the estimated camera geometric information, and storing the color values of the pixels, corresponding to the tie points in the multi-view images used to calculate the tie points, in association with the tie points.

Here, selecting the reference image may include classifying the converted color values into the plurality of multi-view images, respectively, and generating a color value set of each of the multi-view images, calculating a median value of each color value in the generated color value set, and selecting the reference image based on at least one of the calculated median value and a preset rule.

Here, calculating the brightness correction graph may include calculating the brightness correction graph based on a correspondence between a luminance (Y) value of the reference image and a luminance (Y) value of the additional multi-view image, with respect to each tie point.

Here, calculating the brightness correction graph may further include calculating the brightness correction graph using an error measurement method or a monotonic increasing cubic polynomial curve fitting technique, and the error measurement method may include a Root Mean Square Error (RMSE) technique.

Here, correcting the brightness of the additional multi-view image may include converting color values of the multi-view image, the brightness of which is corrected, into RGB channels and storing converted values.

Here, the feature points may be extracted from respective multi-view images using a Scale Invariant Feature Transform (SIFT) technique.

Here, the camera geometric information may be estimated using one of a Perspective-n-Point (PnP) technique, a bundle adjustment technique, a reduced camera system technique, a conjugate gradient technique, or a Structure from Motion (SfM) technique.

In accordance with another aspect of the present disclosure to accomplish the above objects, there is provided an apparatus for correcting brightness of multi-view images, including a storage configured to store a plurality of multi-view images, and a controller configured to calculate tie points in the plurality of multi-view images, store color values of pixels, corresponding to the tie points in multi-view images used to calculate the tie points, in the storage in association with the tie points, convert the stored color values of the pixels into YCbCr channels, select a reference image from among the plurality of multi-view images based on at least one of a luminance (Y) value of converted color values or a preset rule, or a combination thereof, calculate a brightness correction graph between the reference image, selected using the luminance (Y) value, and an additional multi-view image, and correct brightness of the additional multi-view image using the calculated brightness correction graph. Here, the color values of the pixels corresponding to the tie points may be stored in data structures of the tie points. Here, the preset rule may be defined by a user.

Here, the controller may be configured to classify the converted color values into the plurality of multi-view images, respectively, generate a color value set of each of the multi-view images, calculate a median value of each color value in the generated color value set, and select the reference image based on at least one of the calculated median value and a preset rule.

Here, the controller may be configured to calculate the brightness correction graph based on a correspondence between a luminance (Y) value of the reference image and a luminance (Y) value of the additional multi-view image, with respect to each tie point.

Here, the controller may be configured to calculate the brightness correction graph using an error measurement method or a monotonic increasing cubic polynomial curve fitting technique, and the error measurement method may include a Root Mean Square Error (RMSE) technique.

Here, the controller may be configured to convert color values of the multi-view image, the brightness of which is corrected, into RGB channels and store converted values in the storage.

Here, the feature points may be extracted from respective multi-view images using a Scale Invariant Feature Transform (SIFT) technique.

The camera geometric information may be estimated using one of a Perspective-n-Point (PnP) technique, a bundle adjustment technique, a reduced camera system technique, a conjugate gradient technique, or a Structure from Motion (SfM) technique.

The present disclosure may include a computer program stored in a computing device-readable medium to execute the method for correcting brightness of multi-view images according to the present disclosure.

The present disclosure may include a non-transitory computer-readable storage medium for storing instructions, wherein the instructions may be configured to, when being executed by a processor, enable the processor to perform the method for correcting brightness of multi-view images according to the present disclosure, or operations associated with the method for correcting brightness of multi-view images according to the present disclosure.

The present disclosure may include a computer program product including executable instructions for executing the method for correcting brightness of multi-view images according to the present disclosure.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram for explaining a method for capturing multi-view images;

FIG. 2 is a diagram for explaining another method for capturing multi-view images;

FIG. 3 is a block diagram illustrating the configuration of an apparatus for correcting brightness of multi-view images according to an embodiment of the present disclosure;

FIG. 4 is a block diagram illustrating the configuration of a tie point calculation unit according to an embodiment of the present disclosure;

FIG. 5 is a flowchart illustrating a process of performing a method for correcting brightness of multi-view images according to an embodiment of the present disclosure;

FIG. 6 is a flowchart illustrating a process of performing a tie point calculation method according to an embodiment of the present disclosure; and

FIG. 7 is a block diagram illustrating the configuration of an apparatus for correcting brightness of multi-view images according to another embodiment of the present disclosure.

### DESCRIPTION OF THE PREFERRED EMBODIMENTS

The present disclosure may be variously modified and may have various embodiments, and thus specific embodiments will be illustrated in the attached drawings and described in detail in the detailed description of the disclosure. However, this is not intended to limit the present disclosure to particular modes of practice, and it should be appreciated that all changes, equivalents, and substitutes that do not depart from the spirit and technical scope of the present disclosure are encompassed in the present disclosure.

Detailed descriptions of example embodiments to be described later refer to the accompanying drawings illustrating a specific embodiment as an example. These embodiments are described so that those skilled in the art to which the present disclosure pertains can easily practice the embodiments. It should be understood that the various embodiments are different from each other, but are not necessarily mutually exclusive from each other. For example, specific shapes, structures, and characteristics described here may be implemented in other embodiments without departing from the spirit and scope of the present disclosure in relation to one embodiment. In addition, it should be understood that the location or arrangement of individual components within each disclosed embodiment may be changed without departing from the spirit and scope of the embodiments. Therefore, the detailed description which will be made later is not intended to be taken in a limited sense, and the scope of the example embodiments, if appropriate, is limited only by the accompanying claims, along with all of the scope equivalent to those of the accompanying claims.

It should be noted that similar reference numerals in the drawings are used to designate the same or similar functions throughout various aspects. The shapes, sizes, etc. of elements in the drawings may be exaggerated to make the description clearer. Further, the term “and/or” may include a combination of a plurality of related listed items or any of the plurality of related described items. The terms “part,” “unit,” and “module” used in the present disclosure may include one or more components, and may include software components and/or hardware components.

It will be understood that, although the terms “first” and “second” may be used herein to describe various components, these components should not be limited by these terms. These terms are only used to distinguish one component from other components. For instance, a first component may be referred to as a second component without departing from the scope of the present disclosure. Similarly, the second component may also be referred to as the first component.

It should be understood that, when a certain component is described as being “connected” or “coupled” to another component, the two components may be directly connected or coupled to each other, but there may also be other components interposed between the two components. On the other hand, it should be understood that, when a certain component is referred to as being “directly connected” or “directly coupled” to another component, there are no intervening components between the two components.

The components disclosed in the embodiments are depicted independently to represent different characteristic functions, and this does not imply that each component is implemented as separate hardware or a single software component. Each component is listed and included separately for convenience of explanation, but at least two of the components may be combined into a single component, or one component may be divided into multiple components to perform functions thereof. Embodiments in which components are integrated or separated are also included within the scope of the present disclosure, as long as they do not depart from the essence of the present disclosure.

The terms used in embodiments are used only to describe a specific embodiment, and are not intended to limit the present disclosure. A singular expression includes a plural expression unless a description to the contrary is specifically pointed out in context. In embodiments, it should be understood that the terms “comprise”, “include”, and “have” when used in this specification, specify the presence of stated features, integers, steps, operations, elements, components, and/or combinations of them but do not preclude the presence or addition of one or more other features, integers, steps, operations, elements, components, and/or combinations thereof. That is, in embodiments, when it is said that a specific component is “included”, it may mean that components other than the specific component are not excluded and that additional components may be included in the embodiments of the present disclosure or the scope of the technical spirit of the present disclosure.

In embodiments, the term “at least one” may denote one of numbers equal to or greater than 1, such as 1, 2, 3 and 4. In embodiments, the term “a plurality of” may denote one of numbers equal to or greater than 2, such as 2, 3 and 4.

Some components in the embodiments are not essential components that perform intrinsic functions in the present disclosure, but may merely be optional components intended to enhance performance. The embodiments may be implemented to include only the essential components necessary to realize the essence of the embodiments, excluding components used merely for performance enhancement. A structure including only the essential components, excluding optional components used merely for performance enhancement, is also included in the scope of the embodiments.

Hereinafter, embodiments of the present disclosure are described in detail with reference to the accompanying drawings so that those skilled in the art to which the present disclosure pertains can easily practice the present disclosure. In the description of the embodiments, detailed descriptions of known functions or configurations which are deemed to make the gist of the present disclosure obscure will be omitted. Further, the same reference numerals are used to designate the same or similar components throughout the drawings, and repeated descriptions of the same components will be omitted.

Hereinafter, an image may refer to one of pictures constituting video, and may also refer to video itself. For example, “image composition and/or generation” may refer to “video composition and/or generation”, and may also refer to the “composition and/or generation of one of images constituting the video”.

Hereinafter, the terms “video” and “motion picture(s)” may be used to have the same meaning, and may be used interchangeably with each other.

Hereinafter, the terms “image”, “picture”, and “frame” may be used to have the same meaning, and may be used interchangeably with each other.

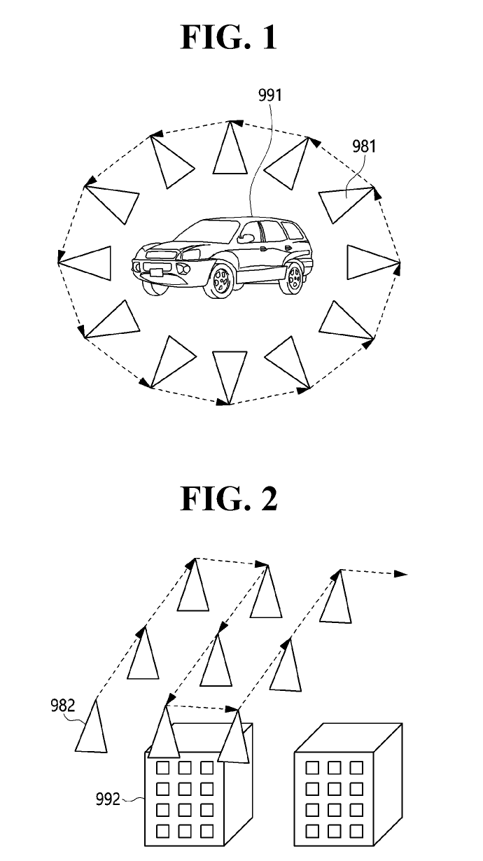

FIG. 1 is a diagram for explaining a method for capturing multi-view images.

Referring to FIG. 1, when capturing multi-view images of a three-dimensional (3D) subject 991, a camera 981 may capture the multi-view images of the 3D subject 991 at each set capturing location while moving at an angle of 360 degrees to face the 3D subject 991. Alternatively, respective cameras may be installed at set capturing locations, and the cameras installed at respective capturing locations may capture multi-view images of the 3D subject 991.

FIG. 2 is a diagram for explaining another method for capturing multi-view images.

Referring to FIG. 2, when a three-dimensional (3D) subject 992 has an area of a certain extent, a drone 982 or the like equipped with a camera may capture multi-view images of the 3D subject 992 while flying in a zigzag pattern.

As illustrated in FIGS. 1 and 2, the multi-view images may be captured by a single camera or by multiple cameras. When multi-view images are captured by a single camera, brightness differences between captured multi-view images are inherently present depending on the capturing time and the capturing location. Also, when the multi-view images are captured by multiple cameras, brightness differences between captured multi-view images are inherently present depending on the brightness difference between the cameras and the capturing location.

The present disclosure may correct brightness differences between the multi-view images that may be inherently present during the capture of multi-view images, and may eliminate a mismatch in surface continuity attributable to the brightness differences between the multi-view images in the results of 3D reconstruction.

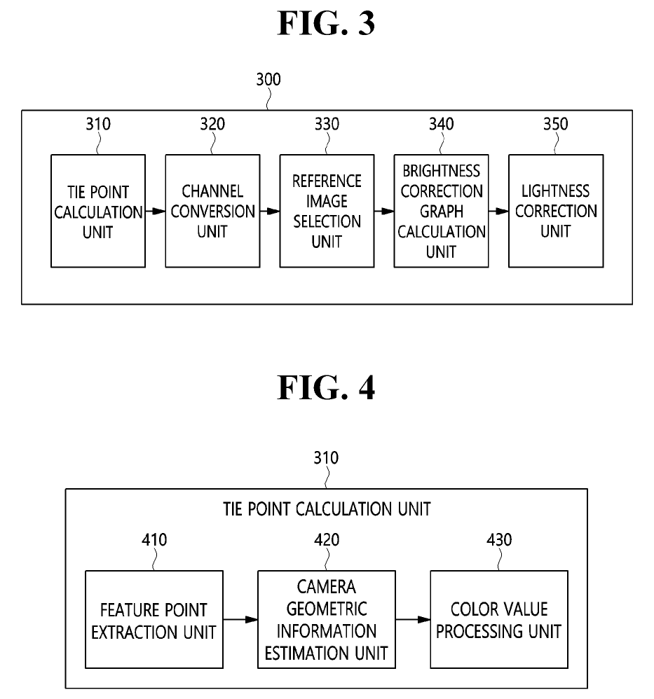

FIG. 3 is a block diagram illustrating the configuration of an apparatus for correcting brightness of multi-view images according to an embodiment of the present disclosure.

Referring to FIG. 3, an apparatus 300 for correcting brightness of multi-view images according to the present disclosure may include a tie point calculation unit 310, a channel conversion unit 320, a reference image selection unit 330, a brightness correction graph calculation unit 340, and a lightness correction unit 350. The apparatus 300 for correcting brightness of multi-view images may be implemented in a computer system including a computer-readable storage (recording) medium.

The tie point calculation unit 310 may calculate tie points in a plurality of multi-view images, and may store color values of pixels, corresponding to the tie points in multi-view images used to calculate the tie points, in association with the tie points. Here, the plurality of multi-view images may be images that are previously stored images or images that are input from at least one camera. The plurality of multi-view images may be images received from at least one camera, electronic device, or server. Further, the plurality of multi-view images may be images captured using the above-described method in FIGS. 1 or 2 .

FIG. 4 is a block diagram illustrating the configuration of a tie point calculation unit according to an embodiment of the present disclosure.

Referring to FIG. 4, the tie point calculation unit 310 may include a feature point extraction unit 410, a camera geometric information estimation unit 420, and a color value processing unit 430.

The feature point extraction unit 410 may extract feature points from a plurality of multi-view images, and calculate correspondences between the extracted feature points by matching the extracted features. The feature point extraction unit 410 may extract feature points from respective multi-view images using a Scale Invariant Feature Transform (SIFT) technique. Further, the feature point extraction unit 410 may match the feature points extracted using the SIFT technique, thus calculating the correspondences between the feature points. In the feature point extraction unit 410, the technique for calculating the correspondences between the feature points in the plurality of multi-view images may be implemented using technology known in the art, in addition to the SIFT technique, and the detailed description thereof is omitted here.

The camera geometric information estimation unit 420 may estimate pieces of camera geometric information of the plurality of multi-view images, respectively, based on the correspondences between feature points calculated by the feature point extraction unit 410. The camera geometric information may be estimated using one of a Perspective-n-Point (PnP) technique, a bundle adjustment technique, a reduced camera system technique, a conjugate gradient technique, or a Structure from Motion (SfM) technique. Further, the technique for estimating the camera geometric information may be implemented using other technologies known in the art, and the detailed description thereof is omitted here.

The color value processing unit 430 may calculate tie points based on the camera geometric information estimated by the camera geometric information 420, and may store the color values of pixels, corresponding to the tie points in multi-view images used to calculate the tie points, in association with the tie points. The color value processing unit 430 may store the color values of the pixels corresponding to the tie points in data structures of the tie points.

The channel conversion unit 320 may convert the color values of the pixels stored in association with the tie points by the tie point calculation unit 310 into YCbCr channels.

The reference image selection unit 330 may select a reference image from among the plurality of multi-view images based on at least one of a luminance (Y) value among color values converted by the channel conversion unit 320, or a preset rule, or a combination thereof.

The reference image selection unit 330 may classify the color values converted by the channel conversion unit 320 into the plurality of multi-view images, respectively, and may then generate color value sets of respective multi-view images. Here, each color value set may include converted color values of a relevant multi-view image.

The reference image selection unit 330 may calculate a median value of each color value in each generated color value set. In some embodiments, the reference image selection unit 330 may select the reference image based on the calculated median value.

In some embodiments, the reference image selection unit 330 may select the reference image based on at least one of preset rules. Here, the preset rules may be defined by a user, and may include a rule for selecting the reference image using respective color values in the generated color value sets.

The brightness correction graph calculation unit 340 may calculate a brightness correction graph between a brightness reference image, selected by the reference image selection unit 340 based on the luminance (Y) value, and other multi-view images. Here, the brightness correction graph calculation unit 340 may calculate the brightness correction graph based on the correspondences between the Y value of the brightness reference image and the Y values of other multi-view images with respect to each tie point. The Y value of the brightness reference image may be a Y value included in the color value set of the reference image, and the Y values of other multi-view images may be Y values included in the color value sets of other multi-view images.

The brightness correction graph calculation unit 340 may calculate the brightness correction graph using an error measurement method or a monotonic increasing cubic polynomial curve fitting technique. The error measurement method may include a Root Mean Square Error (RMSE) technique and other techniques known in the art, and the detailed description thereof is omitted here.

The brightness correction unit 350 may correct the brightness of other multi-view images using the brightness correction graph calculated by the brightness correction graph calculation unit 340. By utilizing the brightness correction graph calculated by the brightness correction graph calculation unit 340, the brightness correction unit 350 may correct the brightness of the remaining multi-view images other than the reference image among the plurality of multi-view images, based on the corresponding brightness correction graph.

The brightness correction unit 350 may convert the color values of the multi-view images, the brightness of which is corrected, into RGB channels, and may store converted color values.

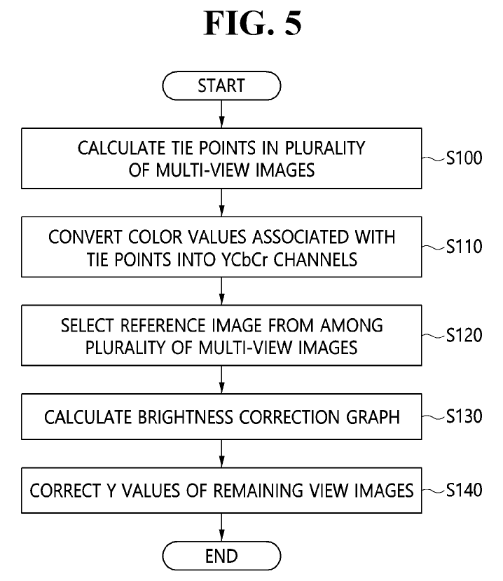

FIG. 5 is a flowchart illustrating a process of performing a method for correcting brightness of multi-view images according to an embodiment of the present disclosure.

Referring to FIG. 5, the tie point calculation unit 310 may calculate tie points in a plurality of multi-view images, and may store the color values of pixels, corresponding to the tie points in multi-view images used to calculate the tie points, in association with the tie points at step S100. Here, the plurality of multi-view images may be images that are previously stored images or images that are input from at least one camera. The plurality of multi-view images may be images received from at least one camera, electronic device, or server. Further, the plurality of multi-view images may be images captured using the above-described method in FIGS. 1 or 2 .

Step S100 may include a process of performing a tie point calculation method according to the present disclosure.

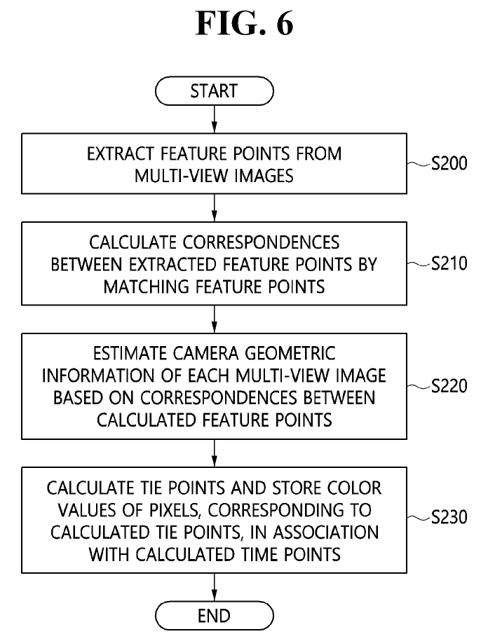

FIG. 6 is a flowchart illustrating a process of performing a tie point calculation method according to an embodiment of the present disclosure.

Referring to FIG. 6, the feature point extraction unit 410 extracts feature points from a plurality of multi-view images at step S200. At step S200, the feature point extraction unit 410 may extract the feature points from respective multi-view images using an SIFT technique. As the method for extracting feature points, technologies known in the art, in addition to the SIFT, may be used, and the detailed description thereof is omitted here.

When the number of a plurality of multi-view images is n, the feature point extraction unit 410 may first extract feature points from each multi-view image Iᵢ (where i is a value between 1 and n), for all of n multi-view images at step S200.

The feature point extraction unit 410 may calculate correspondences between the extracted feature points by matching the feature points at step S210. At step S200, the feature point extraction unit 410 may calculate the correspondences between the feature points by matching the feature points of respective multi-view images using an SIFT technique. As the method for calculating the correspondences between the extracted feature points by matching the feature points, technologies known in the art, in addition to the SIFT, may be used, and the detailed description thereof is omitted here.

When the number of the plurality of multi-view images is n, the feature point extraction unit 410 may calculate the correspondences between the respective feature points by matching the feature points of each view image Iᵢ, extracted at step S200, with the feature points of the remaining n-1 view images at step S210.

The camera geometric information estimation unit 420 estimates pieces of camera geometric information of the plurality of multi-view images, respectively, based on the correspondences between the feature points, calculated at step S210, at step S220. At step S220, the camera geometric information may be estimated using one of a Perspective-n-Point (PnP) technique, a bundle adjustment technique, a reduced camera system technique, a conjugate gradient technique, or a Structure from Motion (SfM) technique. Further, the technique for estimating the camera geometric information may be implemented using other technologies, known in the art, in addition to the above-described technique, and the detailed description thereof is omitted here.

When the number of the plurality of multi-view images is n, the camera geometric information estimation unit 420 may estimate pieces of camera geometric information of n multi-view images Iᵢ at step S220. That is, at step S220, camera geometric information for each of the n multi-view images may be estimated. Here, the camera geometric information may include the location information of a camera at the view from which the multi-view image Iᵢ was captured.

The color value processing unit 430 calculates tie points based on the camera geometric information estimated by the camera geometric information estimation unit 420, and may store the color values of pixels, corresponding to the tie points in multi-view images used to calculate the tie points, in association with the tie points at step S230. The color value processing unit 430 may store the color values of the pixels corresponding to the tie points in the data structures of the tie points.

In the case where the number of the plurality of multi-view images is n, and m tie points are calculated at step S230, when tie point tⱼ(where j denotes a value between 1 and m) among m tie points is calculated, a view image Iᵢ used to calculate each tie point tⱼ and the color value cᵢⱼ of a pixel corresponding to the relevant view image Iᵢ may be stored in the data structure of the tie point tⱼ at step S230. For example, the color value cᵢⱼ stored in the data structure of tⱼ may be the color value of RGB channels.

The channel conversion unit 320 converts the color values of the pixels stored in association with the tie points, calculated at step S100, into YCbCr channels at step S110.

When the number of the plurality of multi-view images is n and m tie points are calculated at step S100, the channel conversion unit 320 may convert all color values cᵢⱼ stored in the data structure of each tie point tⱼ, for the m tie points, into YCbCr channels at step S110.

The reference image selection unit 330 selects a reference image from among the plurality of multi-view images based on at least one of a luminance (Y) value among color values converted by the channel conversion unit 320, or a preset rule, or a combination thereof at step S120.

At step S120, the reference image selection unit 330 may classify the color values converted by the channel conversion unit 320 into the plurality of multi-view images, respectively, and may then generate color value sets of respective multi-view images. Here, each color value set may include converted color values of a relevant multi-view image.

When the number of the plurality of multi-view images is n, and m tie points are calculated at step S100, the reference image selection unit 330 may classify all color values cᵢⱼ stored in the data structure of each tie point tⱼ, for the m tie points, into respective multi-view images Iᵢ and may then generate color value sets Cᵢ of the multi-view images Iᵢ at step S120.

At step S120, the reference image selection unit 330 may calculate a median value of each color value in each generated color value set.

When the number of the plurality of multi-view images is n, and m tie points are calculated at step S100, and n color value sets are calculated, the reference image selection unit 330 may calculate a median value eᵢ of a color value cᵢⱼ in each color value set Cᵢ, for the n color value sets.

At step S120, the reference image selection unit 330 may select the reference image based on at least one of the calculated median value or the preset rule, or a combination thereof. The preset rule may be defined by a user, or may be selected by a producer.

When the number of the plurality of multi-view images is n, the reference image selection unit 330 may select ‘t’ of reference image Iₜ (where t is a value between 1 and n).

At step S120, the reference image selection unit 330 may select the reference image from among the plurality of multi-view images based on the calculated median value. In the case where the median value eᵢ of the color value cᵢⱼ in each color value set Cᵢ, for the n color value sets, is calculated, the reference image selection unit 330 may select a view image, in which the calculated median value eᵢ is the median value of all multi-view images, as the reference image.

The brightness correction graph calculation unit 340 calculates a brightness correction graph between a brightness reference image, selected by the reference image selection unit 340 based on the luminance (Y) value, and other multi-view images at step S130. At step S130, the brightness correction graph calculation unit 340 may obtain the brightness correction graph based on the correspondences between the Y value of a brightness reference image and Y values of other multi-view images, with respect to each tie point. The Y value of the brightness reference image may be a Y value included in the color value set of the reference image, and the Y values of other multi-view images may be Y values included in the color value sets of other multi-view images.

Furthermore, at step S130, the brightness correction graph calculation unit 340 may calculate the brightness correction graph using an error measurement method or a monotonic increasing cubic polynomial curve fitting technique. The error measurement method may include a Root Mean Square Error (RMSE) technique and other techniques known in the art, and the detailed description thereof is omitted here.

When the number of the plurality of multi-view images is n, m tie points are calculated at step S100, and the brightness reference image Iₜ is selected at step S120, the brightness correction graph calculation unit 340 may calculate the brightness correction graph Gᵢ using Y value correspondences between the brightness reference image Iₜ corresponding to each tie point tⱼ and a target view image Iᵢ, for the m tie points, at step S130. Here, the brightness correction graph calculation unit 340 may calculate the brightness correction graph by utilizing an existing technique such as an error measurement method such as RMSE, or a monotonic increasing cubic polynomial curve fitting technique. At step S130, the brightness correction graph calculation unit 340 calculates n brightness correction graphs for the n multi-view images by calculating brightness correction graphs for respective multi-view images.

The brightness correction unit 350 corrects the brightness of other multi-view images using the brightness correction graph, calculated at step S130, at step S140. At step S130, by utilizing the brightness correction graph calculated by the brightness correction graph calculation unit 340, the brightness correction unit 350 may correct the brightness of the remaining multi-view images other than the reference image among the plurality of multi-view images, based on the corresponding brightness correction graph. Further, at step S140, the brightness correction unit 350 may convert the color values of the multi-view images, the brightness of which is corrected, into RGB channels, and may store converted color values.

When n brightness correction graphs are calculated for n multi-view images at step S130, the brightness correction graph calculation unit 340 may correct the brightness of the luminance (Y) value of each image Iᵢ using the brightness correction graph Gᵢ for each image Iᵢ, and may convert the corrected color value into RGB channels and store converted color values.

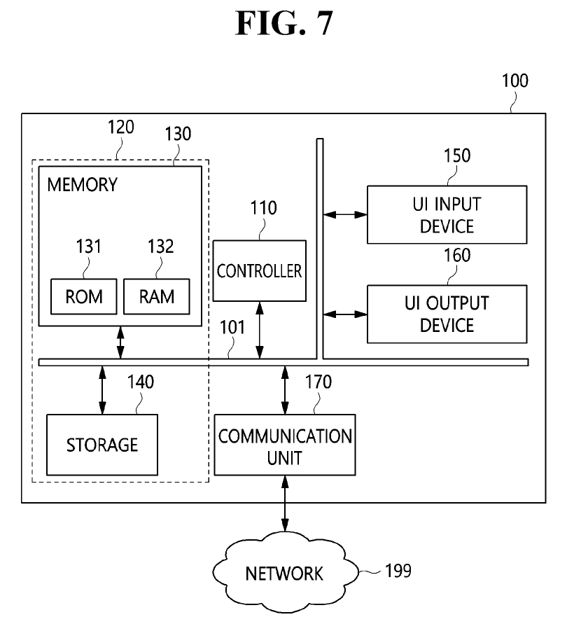

FIG. 7 is a block diagram illustrating the configuration of an apparatus for correcting brightness of multi-view images according to another embodiment of the present disclosure.

Referring to FIG. 7, an apparatus 100 for correcting brightness of multi-view images may include a bus 101, a controller 110, a storage 120, a user interface (UI) input device 150, a UI output device 160, and a communication unit 170. The storage 120 may include a memory 130 and a storage 140. The controller 110, the memory 130, the storage 140, the UI input device 150, the UI output device 160, and the communication unit 170 may communicate with each other through the bus 101. The apparatus 100 for correcting brightness of multi-view images may be a computer system.

The controller 110 may be a semiconductor device which executes processing instructions stored in the memory 130 or the storage 140. The controller 110 may be at least one hardware processor. The controller 110 may be composed of one or more cores, and may include processors for data analysis and deep learning, such as a Central Processing Unit (CPU), a Graphics Processing Unit (GPU), a Digital Signal Processor (DSP), an Application Specific Integrated Circuit (ASIC), a general purpose graphics processing unit (GPGPU), and a Tensor Processing Unit (TPU) of the apparatus 100 for correcting brightness of multi-view images. The controller 110 may perform data processing to train a deep learning network according to an embodiment of the present disclosure by reading a computer program loaded in the memory 130.

The controller 110 may execute instructions, and may perform operations associated with the apparatus 100 for correcting brightness of multi-view images. For example, by utilizing instructions retrieved from the storage 140, the controller 110 may control input, output, and data reception and processing between the components of the apparatus 100 for correcting brightness of multi-view images.

The controller 110 may perform generation and processing of signals, data or information that are input to the apparatus 100 for correcting brightness of multi-view images, are output from the apparatus 100 for correcting brightness of multi-view images, or are used within the apparatus 100 for correcting brightness of multi-view images, and may perform tests, comparison, determination, and the like that are related to the signals, data or information. In other words, in an embodiment, the generation and processing of data or information and the tests, comparison, and determination related to the data or information may be performed by the controller 110.

The controller 110 may generate a bitstream. The controller 110 may perform operations for generating the bitstream described in embodiments.

At least some of components, units or modules described in the following embodiments may be program modules, and may communicate with an external device or system. The program modules may be included in the apparatus 100 for correcting brightness of multi-view images in the form of an operating system, an application module, and other program modules.

The program modules may be physically stored in various known storage devices. Further, at least some of the program modules may be stored in a remote storage device that is capable of communicating with the apparatus 100 for correcting brightness of multi-view images.

The program modules may include, but are not limited to, a routine, a subroutine, a program, an object, a program component, a data structure, etc., which perform functions or operations according to an embodiment or implement an abstract data type according to an embodiment.

The program modules may be implemented using instructions or codes that are executed by at least one processor of the apparatus 100 for correcting brightness of multi-view images100.

The controller 110 may execute the instructions or codes of components, units or modules described in embodiments.

The communication unit 170 may transmit or receive signals or data to or from a multi-view image provision server, other servers or other terminals over the network 199. The network 199 may be a private network or the Internet, and may include a wired network or a wireless network. The network 199 may refer to one or more parts of a network that can be an ad hoc network, intranet, extranet, Bluetooth, ZigBee, Virtual Private Network (VPN), Local Area Network (LAN), Wireless LAN (IEEE 802.11b, IEEE 802.11a, IEEE 802.11g, IEEE 802.11n), Wireless Broadband (WiBro), Wide Area Network (WAN), Wireless WAN (WWAN), Metropolitan Area Network (MAN), the Internet, a portion of the Internet, a portion of a Public Switched Telephone Network (PSTN), a Plain Old Telephone Service (POTS) network, a cellular telephone network, a wireless network, a Wi-Fi® network, other types of networks, or any combination of two or more of such networks. Further, the network 199 may also refer to one or more parts of a network that is connected to other types of networks. For example, the network or a part of the network may include a wireless or cellular network, and connection may be Code Division Multiple Access (CDMA) connection, Global System for Mobile communications (GSM) connection, or other types of cellular or wireless connections. In this example, connection may be implemented using any of various types of data transmission technologies, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation (4G) wireless networks, Universal Mobile Telecommunications System (UMTS), High Speed Packet Access (HSPA), Worldwide Interoperability for Microwave Access (WiMAX), Long Term Evolution (LTE) standards, other technologies defined by various standard-setup organizations, other long-distance protocols, or other data transmission technologies.

The communication unit 170 may transmit or receive signals or data to or from a server for providing multi-view images, or other terminals using a Local Area Network (LAN), Wireless LAN (e.g., IEEE 802.11b, IEEE 802.11a, IEEE802.11g, or IEEE802.11n), Wireless Broadband (WIBro), Bluetooth, ZigBee, or the like.

Functions related to communication of data or information of the apparatus 100 for correcting brightness of multi-view images may be performed through the communication unit 170.

For example, the communication unit 170 may receive a plurality of multi-view images over the network 199. The communication unit 170 may receive the plurality of multi-view images from at least one camera, electronic device, or server.

The storage 120 may refer to the memory 130 and/or the storage 140. Each of the memory 130 and the storage 140 may be any of various types of volatile or nonvolatile storage media. For example, the memory 130 may include at least one of Read Only Memory (ROM) 131 and Random Access Memory (RAM) 132.

The storage 120 may store data or information used for the operation of the apparatus 100 for correcting brightness of multi-view images. In an embodiment, the data or the information of the apparatus 100 for correcting brightness of multi-view images may be stored in the storage.

A recording medium may store at least one module required by the apparatus 100 for correcting brightness of multi-view images to perform operations. The storage 140 or the ROM 131 may store at least one module. The at least one module stored in the recording medium may be configured to be accessed from the recording medium by the controller 110, and may be loaded into the RAM 132 and then executed.

The storage 140 may store a plurality of multi-view images. Here, the plurality of multi-view images stored in the storage 140 may be images input from at least one camera, may be images input by a user, or may be images received by the communication unit 170. Further, the plurality of multi-view images may be images captured using the above-described method in FIGS. 1 or 2 .

The UI input device 150 may be configured to receive input data and transfer the input data to the controller 110. The UI input device 150 may receive a plurality of multi-view images from the user or the camera.

The UI output device 160 may be configured to output the results of processing by the controller 110.

The controller 110 may implement methods described with reference to FIGS. 5 and 6. Further, the controller 110 may be configured to perform functions of the tie point calculation unit 310, the channel conversion unit 320, the reference image selection unit 330, the brightness correction graph calculation unit 340, and the brightness correction unit 350. That is, the controller 110 may load the plurality of multi-view images to the RAM 132, and may perform functions of tie point calculation unit 310, the channel conversion unit 320, the reference image selection unit 330, the brightness correction graph calculation unit 340, and the brightness correction unit 350 for the plurality of loaded multi-view images. Here, the plurality of multi-view images may include the plurality of multi-view images stored in the storage 140, the plurality of multi-view images received by the communication unit 170, or the plurality of multi-view images received by the UI input device 150.

In the above-described embodiments, when applying specific processing to a specific target, a specific condition may be required. In the case where it is described that the specific processing is performed under a specific determination, when it is described that the determination of whether the specific condition is satisfied is made based on a specific coding parameter, or that a specific determination is made based on a specific coding parameter, such coding parameters may be construed as being replaceable with other coding parameters. In other words, the coding parameter influencing the specific condition or the specific determination may be regarded as being exemplary, and it may be understood that combinations of one or more other coding parameters in addition to the specified coding parameter perform the function of the specified coding parameter.

In the above-described embodiments, although the methods have been described as a series of steps or units, based on flowcharts, the present disclosure is not limited by the order of the steps, and some steps may occur as steps different from the above-described steps or in an order different from that of the above-described steps, or simultaneously with the above-described steps. Further, those skilled in the art will understand that the steps shown in the flowchart are not exclusive, and that other steps may be included, or one or more of the steps in the flowchart may be omitted without departing from the scope of the present disclosure.

The above-described embodiments include examples in various aspects. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments of the present disclosure may be implemented in the form of program instructions that can be executed through various computer components and may be recorded in a computer-readable recording (storage) medium. The computer-readable recording medium may include program instructions, data files, and data structures, either solely or in combination. The program instructions recorded on the computer-readable recording medium may be specifically designed and configured for the present disclosure, or may be disclosed and available to those skilled in computer software fields.

The computer-readable recording medium may include information used in embodiments according to the present disclosure. For example, the computer-readable recording medium may include a bitstream, and the bitstream may include information described in embodiments of the present disclosure.

The bitstream may include computer-executable code and/or program. The computer-executable code and/or program may include pieces of information described in the embodiments, and may include syntax elements described in the embodiments. In other words, the pieces of information and syntax elements described in the embodiments may be regarded as a computer-readable code in the bitstream, and may be regarded as at least part of the computer-executable code and/or program represented by the bitstream.

The computer-readable recording medium may include a non-transitory computer-readable medium.

Examples of the computer-readable recording medium include hardware devices specially configured to store and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of program instructions include not only machine language code created by a compiler but also high-level language code that can be executed by a computer using an interpreter or the like. The foregoing hardware devices may be configured to operate as one or more software modules in order to perform processing according to the present disclosure, and vice versa.

In accordance with the method and apparatus for correcting brightness of multi-view images according to the present disclosure, a brightness correction graph calculated based on the configuration of the present disclosure is calculated through correspondences accurately predicted for each image, thus guaranteeing uniform brightness correction performance in all images. Further, the present disclosure is advantageous in that, in a 3D space reconstruction process using multi-view images, brightness of the multi-view images can be corrected using only a simple computation in an intermediate stage.

While the present disclosure has been described above with reference to specific details such as detailed components, limited embodiments, and drawings, these have been provided merely for the purpose of facilitating a more comprehensive understanding of the disclosure. The present disclosure is not limited to the above-described embodiments, and those skilled in the art to which the present disclosure pertains can make various changes and modifications based on the description thereof.

Accordingly, the spirit of the present disclosure should not be construed as being limited to the described embodiments, and all modifications and variations that are made equally or equivalently to the accompanying claims may fall within the scope of the spirit of the present disclosure.

What is claimed is:

1. A method for correcting brightness of multi-view images, comprising:
calculating tie points in a plurality of multi-view images, and storing color values of pixels, corresponding to the tie points in multi-view images used to calculate the tie points, in association with the tie points;
converting the stored color values of the pixels into YCbCr channels;
selecting a reference image from among the plurality of multi-view images based on at least one of a luminance (Y) value of converted color values or a preset rule, or a combination thereof;
calculating a brightness correction graph between the reference image, selected based on the luminance (Y) value, and an additional multi-view image; and
correcting brightness of the additional multi-view image using the calculated brightness correction graph.

2. The method of claim 1, wherein storing the color values of the pixels in association with the tie points comprises:
extracting feature points from the multiple the plurality of multi-view images and calculating correspondences between the extracted feature points by matching the feature points;
estimating pieces of camera geometric information of the plurality of multi-view images based on the calculated correspondences; and
calculating the tie points based on the estimated camera geometric information, and storing the color values of the pixels, corresponding to the tie points in the multi-view images used to calculate the tie points, in association with the tie points.

3. The method of claim 1, wherein the color values of the pixels corresponding to the tie points are stored in data structures of the tie points.

4. The method of claim 1, wherein selecting the reference image comprises:
classifying the converted color values into the plurality of multi-view images, respectively, and generating a color value set of each of the multi-view images;
calculating a median value of each color value in the generated color value set; and
selecting the reference image based on the calculated median value.

5. The method of claim 1, wherein the preset rule is defined by a user.

6. The method of claim 1, wherein calculating the brightness correction graph comprises:
calculating the brightness correction graph based on a correspondence between a luminance (Y) value of the reference image and a luminance (Y) value of the additional multi-view image.

7. The method of claim 6, wherein calculating the brightness correction graph further comprises:
calculating the brightness correction graph using an error measurement method or a monotonic increasing cubic polynomial curve fitting technique.

8. The method of claim 1, wherein correcting the brightness of the additional multi-view image comprises:
converting color values of the multi-view image, the brightness of which is corrected, into RGB channels and storing converted values.

9. The method of claim 2, wherein the feature points are extracted from respective multi-view images using a Scale Invariant Feature Transform (SIFT) technique.

10. The method of claim 2, wherein the camera geometric information is estimated using one of a Perspective-n-Point (PnP) technique, a bundle adjustment technique, a reduced camera system technique, a conjugate gradient technique, or a Structure from Motion (SfM) technique.

11. An apparatus for correcting brightness of multi-view images, comprising:
a storage configured to store a plurality of multi-view images; and
a controller configured to calculate tie points in the plurality of multi-view images, store color values of pixels, corresponding to the tie points in multi-view images used to calculate the tie points, in the storage in association with the tie points, convert the stored color values of the pixels into YCbCr channels, select a reference image from among the plurality of multi-view images based on at least one of a luminance (Y) value of converted color values or a preset rule, or a combination thereof, calculate a brightness correction graph between the reference image, selected using the luminance (Y) value, and an additional multi-view image, and correct brightness of the additional multi-view image using the calculated brightness correction graph.

12. The apparatus of claim 11, wherein the controller is configured to extract feature points from the multiple the plurality of multi-view images, calculate correspondences between the extracted feature points by matching the feature points, estimate pieces of camera geometric information of the plurality of multi-view images based on the calculated correspondences, calculate the tie points based on the estimated camera geometric information, and store the color values of the pixels, corresponding to the tie points in the multi-view images used to calculate the tie points, in the storage in association with the tie points.

13. The apparatus of claim 11, wherein the color values of the pixels corresponding to the tie points are stored in data structures of the tie points.

14. The apparatus of claim 11, wherein the controller is configured to classify the converted color values into the plurality of multi-view images, respectively, generate a color value set of each of the multi-view images, calculate a median value of each color value in the generated color value set, and select the reference image based on the calculated median value.

15. The apparatus of claim 11, wherein the preset rule is defined by a user.

16. The apparatus of claim 11, wherein the controller is configured to calculate the brightness correction graph based on a correspondence between a luminance (Y) value of the reference image and a luminance (Y) value of the additional multi-view image.

17. The apparatus of claim 16, wherein the controller is configured to calculate the brightness correction graph using an error measurement method or a monotonic increasing cubic polynomial curve fitting technique.

18. The apparatus of claim 11, wherein the controller is configured to convert color values of the multi-view image, the brightness of which is corrected, into RGB channels and store converted values in the storage.

19. The apparatus of claim 12, wherein the feature points are extracted from respective multi-view images using a Scale Invariant Feature Transform (SIFT) technique.

20. A program or software stored in a medium readable by a computing device, the program or software, when executed by one or more processors of the computing device, causing the computing device to:
calculate tie points in a plurality of multi-view images, and store color values of pixels, corresponding to the tie points in multi-view images used to calculate the tie points, in association with the tie points;
convert the stored color values of the pixels into YCbCr channels;
select a reference image from among the plurality of multi-view images based on at least one of a luminance (Y) value of converted color values or a preset rule, or a combination thereof;
calculate a brightness correction graph between the reference image, selected based on the luminance (Y) value, and an additional multi-view image; and
correct brightness of the additional multi-view image using the calculated brightness correction graph.
